(19) United States
(12) Patent Application Publication
(10) Pub. No.: US 2003/0095682 A1
(43) Pub. Date: May 22, 2003

(54) Apparatus and method for embedding and extracting digital watermarks based on wavelets

(76) Inventors: Sanghyun Joo, Daejeon (KR); Yong-Seok Seo, Daejeon (KR); Young Ho Suh, Daejeon (KR)

Correspondence Address: JACOBSON HOLMAN PLLC, 400 SEVENTH STREET N.W., SUITE 600, WASHINGTON, DC, 20004, US

(21) Appl. No.: 10/098,469

(22) Filed: Mar. 18, 2002

(30) Foreign Application Priority Data
Nov. 20, 2001 (KR) 2001-72191

(51) Int. Cl. G06K 9/00

(52) U.S. Cl. 382/100

(57) ABSTRACT

An apparatus and method for embedding and extracting digital watermarks based on wavelets which is robust to external attacks while being capable of minimizing a degradation in picture quality caused by embedding of the watermarks. The embedded watermarks embedded in DC component domains of wavelet-transformed domains can be robust to external attacks such as compression. The high-frequency dependency of pixels in a DC component domain determined as a target domain, in which watermarks are to be embedded, is calculated, in order to embed the watermarks in the target domain in the order of pixels having a higher high-frequency dependency. Accordingly, there is an advantage in that it is possible to minimize a degradation in picture quality caused by the embedding of watermarks in the DC component domain.

### FIELD OF THE INVENTION

The present invention relates to digital watermarking; and, more particularly, to an apparatus and method for embedding and extracting digital watermarks based on wavelets which is robust to external attacks while being capable of minimizing a degradation in picture quality caused by embedding of the watermarks.

### BACKGROUND OF THE INVENTION

Change from the analog age to the digital age has been rapidly progressing, as apparent from generalization of digital media, great and a wide growth of electronic publishing industries, digitalization of diverse multimedia contents, and rapid development of digital communication networks such as the Internet, all of which have been recently made. That is, transfer and exchange of diverse data associated with e-books, Internet TV, images, videos, MP3, etc. are currently enabled. Using such multimedia services, therefore, users can rapidly and easily obtain desired information.

However, the change to the digital age involves various adverse effects. For example, the development of digital techniques has allowed a large number of copies to be produced. Furthermore, the development of communication networks has allowed the distribution of copies without any limitation. For this reason, creative works of individuals may be unreasonably used by stealth. Practically, such adverse effects have been highlighted as significant problems to be surely eliminated to providers, who provide data services such as MP3 files or moving picture data over the Internet.

Meanwhile, copies of analog data, for example, books, analog tapes, films, or painted pictures have a degraded quality. In order to prevent such a degradation in quality, it is necessary to produce copies identical to the original data. However, this is technically impossible. Although owners of copyrights have a preference for digital data because of the above mentioned drawback of analog data, the digital data also has a drawback in that it is impossible to distinguish the original data from its copies due to the digital property thereof. For this reason, it is strongly required to provide solutions for protection of copyrights of digital data against unauthorized duplication, distribution and modification of the digital data, and authentication associated with those copyrights.

To this end, techniques for preventing unauthorized copying of digital data have been developed. For example, information protection schemes such as cryptography and firewall have been proposed. However, such methods are incompatible with the features of the Web because most of them basically prevent access to data. Furthermore, there is no reliable measure to prevent unauthorized copying and modification of digital data made by users allowed to have access to the digital data.

Accordingly, research has been performed to provide various copying prevention techniques for effectively preventing copying of digital data, thereby protecting the copyrights of the digital data. For example, research has been actively performed in association with a digital watermarking method, which is known to be effective for prevention of copying of digital data.

Watermarking is a technique developed to prevent copying of digital contents. In accordance with this technique, the owner of a copyright can embed, in a multimedia content created by him, a specific stream of digital data representing information about the ownership of the multimedia content while being visually and audibly imperceptible. Such a specific digital data stream is called a “watermark”. Digital watermarking methods are mainly classified into a method of embedding a watermark in a spatial domain, and a method of embedding a watermark in a frequency domain. Watermarking in spatial domains can be easily performed while requiring a relatively small amount of calculation. However, it is difficult to apply this watermarking method to images compressed by a technique such as JPEG (Joint Photographic Experts Group). In addition, this watermarking method has a problem in that the embedded watermark is quite sensitive to noise. For this reason, watermarking in frequency domains has been known as being more effective than the watermarking in spatial domains. Therefore, the watermarking in frequency domains has been mainly used.

For the watermarking method based on frequency domains, I. J. Cox has proposed a method in which the entire domain of an image is processed by DCT (Discrete Cosine Transform) without being divided into blocks so that random noise proportional to DCT coefficients are embedded, as watermark signals, in the domains, except for the low frequency domain. In addition, various watermarking methods based on DCT domains have been proposed. For example, a watermarking method based on block DCT has been proposed in which insertion of a watermark is determined based on a JND (Just Noticeable Difference) value using human visual characteristics. In accordance with this method, a product by the JND value is embedded as a watermark signal. Recently, a method has been proposed in which a visually-imperceptible watermark is embedded in a DC component of a DCT domain.

Meanwhile, in pace with the recently increased demand for highly efficient compression of image and video data, research for compression of image data is actively conducted in association with image data compression using a wavelet transform, as compared to image data compression using a DCT, which involves a blocking phenomenon in the encoding of super-low-speed moving pictures. In particular, the watermarking methods based on DCT domains is ineffective in JPEG 2000, that is, a new image compression standard recently established for Internet environments because compression of images is performed based on a wavelet transform in the JPEG 2000, different from the existing JPEG standards based on DCT. Based on this background, research for watermarking methods based on wavelets is actively conducted.

Various watermarking methods based on the wavelet transform have been proposed. For example, there is a watermarking method in which watermark signals having different lengths are embedded in all high-frequency domains, except for the lowest-frequency domain, respectively. Also, a watermarking method has been proposed in which a watermark signal is embedded in a coefficient having a larger value. In most of the proposed methods, a watermark is embedded in frequency components, except for DC components, that is, the lowest-frequency components, after a frequency transform including a wavelet transform, taking into consideration the human's visual characteristics more sensitive to a variation in low-frequency components than to a variation in high-frequency components. However, these methods still have problems in that the watermark is considerably damaged when the high-frequency components are eliminated in accordance with a compression process such as JPEG compression.

On the other hand, a technique for embedding watermarks in DC components has been disclosed in “Embedding Image Watermarks in DC Components”, “IEEE Trans. Circuits and Systems for Video Technology” Volume 10, No. 6, pp 974-979, Sep. 2000. In this technique “Embedding Image Watermarks in DC Components”, embedding of a watermark in a DC component has been proposed as a method for enhancing the robustness of the watermark to attacks based on, for example, JPEG. This technique is not based on wavelets, but based on DCT. That is, an image is subjected to a DCT for respective blocks thereof, and the resultant blocks are sorted into two groups in accordance with texture intensities thereof so that different scaling factors are adaptively applied to respective block groups, in order to make watermarks have different intensities. However, this technique cannot provide solutions to a degradation in picture quality due to embedding of watermarks in DC components.

### SUMMARY OF THE INVENTION

Therefore, an object of the invention is to provide an apparatus and method for embedding and extracting digital watermarks based on wavelets, in which the watermarks are embedded in DC component domains of wavelet-transformed domains in the order of pixels having a higher high-frequency dependency, so that they are robust to external attacks such as compression while minimizing a degradation in picture quality caused by the embedding thereof.

In accordance with one aspect, the present invention provides a digital watermark embedding apparatus based on wavelets including: a high-frequency component removing unit for removing high-frequency components from a target image corresponding to a target domain of a wavelet-transformed original image, in which watermarks are to be embedded, thereby generating a mirror image corresponding to the target domain free of high-frequency components; an index information generating unit for comparing data values of pixels in the target image with data values of pixels in the mirror image, respectively, thereby detecting position information of the pixels having higher high-frequency dependencies in the target image, the index information generating unit serving to arrange the detected pixel position information in the order of pixels having higher high-frequency dependencies, thereby generating an index information about the arranged pixel position information; a watermark generating unit for generating a data stream of the watermarks to be embedded in the target image; and a watermark embedding unit for embedding the watermarks of the watermark data stream generated from the watermark generating unit in pixel data of the target image at positions determined based on the index information from the index information generating unit, respectively.

In accordance with another aspect, the present invention provides a digital watermark extracting apparatus based on wavelets including: a high-frequency component removing unit for removing high-frequency components from a target image corresponding to a target domain of a wavelet-transformed original image, in which original watermarks are to be embedded, thereby generating a mirror image corresponding to the target domain free of high-frequency components; an index information generating unit for comparing data values of pixels in the target image with data values of pixels in the mirror image, respectively, thereby detecting position information of the pixels having higher high-frequency dependencies in the target image, the index information generating unit serving to arrange the detected pixel position information in the order of pixels having higher high-frequency dependencies, thereby generating an index information about the arranged pixel position information; a watermark generating unit for generating a data stream of the original watermarks to be embedded in the target image; a watermark extracting unit for receiving the index information from the index information generating unit, receiving a watermark-embedded image corresponding to a watermark-embedded domain of the wavelet-transformed original image, and extracting a data stream of watermarks from in the watermark-embedded image, based on the index information; and a watermark comparing unit for checking a similarity between the original watermark data stream from the watermark generating unit and the extracted watermark data stream from the watermark extracting unit, thereby determining whether or not the original watermarks are embedded in the wavelet-transformed original image.

In accordance with another aspect, the present invention provides a digital watermark embedding method based on wavelets in a digital watermark embedding apparatus including a high frequency removing unit, an index information generating unit, a watermark generating unit, and a watermark embedding unit, including the steps of: (a) executing a multi-level wavelet transform at a level corresponding to the size of a data stream of watermarks to be embedded, for an original image, in which the watermarks are to be embedded, and setting a target domain of the wavelet-transformed image, in which the watermarks are to be embedded; (b) removing high-frequency components from a target image corresponding to the set target domain, thereby generating a mirror image corresponding to the target image, but free of high-frequency components; (c) comparing data values of pixels in the target image with data values of pixels in the mirror image, respectively, thereby detecting position information of the pixels having higher high-frequency dependencies in the target image, and arranging the detected pixel position information in the order of pixels having higher high-frequency dependencies, thereby generating an index information about the arranged pixel position information; and (d) embedding the watermarks of the watermark data stream in pixel data of the target image at positions determined based on the index information, respectively.

In accordance with another aspect, the present invention provides a digital watermark extracting embedding method based on wavelets in a digital watermark extracting apparatus including a high frequency removing unit, an index information generating unit, a watermark generating unit, a watermark extracting unit, and a watermark comparing unit, including the steps of: (a′) generating position information about pixels, in which a data stream of original watermarks is to be embedded, based on a target image corresponding to a target domain of a wavelet-transformed original image, in which the target watermark data stream is to be embedded; (b′) receiving data of pixels in a watermark-embedded domain, in which the original watermark data stream has been embedded; (c′) extracting a watermark data stream from the received pixel data, based on the pixel position information; and (d′) checking a similarity between the original watermark data stream and the extracted watermark data stream, thereby determining whether or not the original watermarks are embedded in the wavelet-transformed original image.

### BRIEF DESCRIPTION OF THE DRAWINGS

The above and other objects and features of the present invention will become apparent from the following description of preferred embodiments given in conjunction with the drawings, in which:

FIGS. 1a and 1b are concept diagrams respectively illustrating a procedure for setting a target domain, in which watermarks are to be embedded, in accordance with an embodiment of the present invention;

FIG. 2 is a concept diagram illustrating a procedure for removing high-frequency components from the target domain;

FIG. 3 is a block diagram illustrating an apparatus for embedding digital watermarks based on wavelets in accordance with an embodiment of the present invention;

FIG. 4 is a concept diagram illustrating a procedure for embedding watermarks based on wavelets using the watermark embedding apparatus in accordance with an embodiment of the present invention;

FIG. 5 is a block diagram illustrating an apparatus for extracting digital watermarks based on wavelets in accordance with an embodiment of the present invention; and

FIG. 6 is a concept diagram illustrating a procedure for extracting watermarks based on wavelets using the digital watermark extracting apparatus in accordance with an embodiment of the present invention.

### DETAILED DESCRIPTION OF THE PREFERRED EMBODIMENTS

Now, preferred embodiments of the present invention will be described with reference to the annexed drawings.

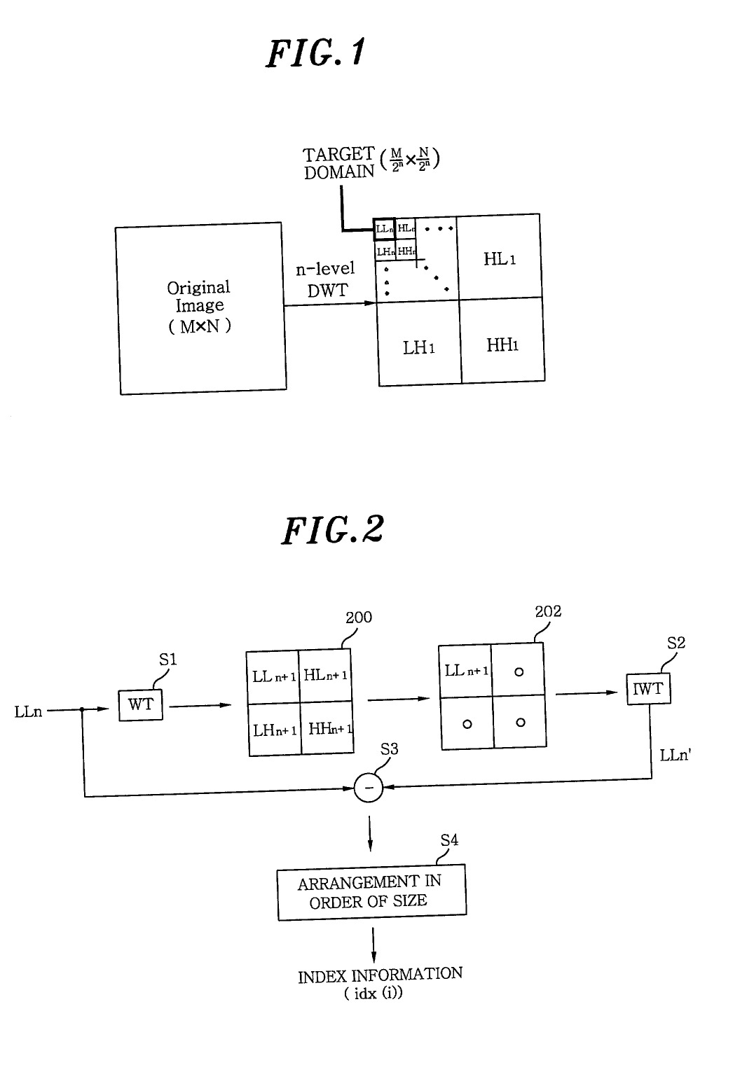

FIGS. 1a and 1b are concept diagrams illustrating a wavelet transform procedure for embedding watermarks in an image in accordance with an embodiment of the present invention. Where it is desired to embed watermarks in a particular image shown in FIG. 1a for protection of the copyright for the image, it is necessary to decompose the original image into wavelets in order to determine domains, in which a watermark is to be embedded. That is, an n-level wavelet transform should be performed for the original image, as shown in FIG. 1b. The level of wavelet transform determines the size of a DC domain, in which a watermark is to be embedded. Accordingly, the wavelet transform level must be appropriately determined so that it prevents a degradation in picture quality caused by the embedding of the watermark. For example, when a DC domain has the same size as its original image, it can allow a maximum number of watermarks to be embedded therein. Generally, where an n-level wavelet transform for an image having an M×N size is performed, a domain LLₙ may be determined as a target domain, in which a watermark is to be embedded, as expressed by the following Expression 1:

$$size ( {LL}_{n} ) = \frac{M}{{2}^{n}} \times \frac{N}{{2}^{n}} \qquad [ Expression 1 ]$$

The size of the target domain may be determined, taking into consideration the length and embedding strength of a watermark data stream to be embedded, and the level of a degradation in picture quality caused by the embedding of the watermark data stream.

Where the domain LLₙ is determined as a target domain, in which a watermark is to be embedded, a procedure for removing high-frequency components from the target domain LLₙ should be executed. In this procedure, the high-frequency dependency of each pixel in the target domain LLₙ is checked in order to conduct the embedding of a watermark data stream in the pixels of the target domain LLₙ in the order of pixels having a higher high-frequency dependency. In accordance with this procedure, it is possible to prevent a degradation in picture quality caused by the embedding of watermarks. In the illustrated embodiment of the present invention, the original image is wavelet-transformed to estimate and detail domains. The watermark data stream is embedded in the estimate domain, which consists of DC components, for a desired robustness of the watermark data. Where the watermark data stream is randomly embedded in the pixels of wavelet-transformed DC component domain, a severe degradation in picture quality may occur. In order to minimize a degradation in picture quality caused by the embedding of watermark data, therefore, the watermark data is preferentially embedded in those, exhibiting a higher high-frequency dependency, of the pixels of the DC component domain, in accordance with the present invention, taking into the consideration the fact that the visual characteristics of humans are more sensitive to a variation in low-frequency components than to a variation in high-frequency components.

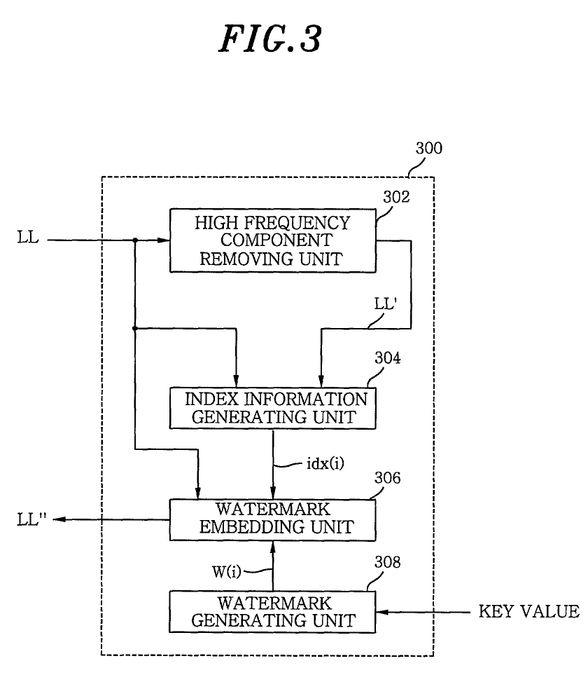

FIG. 2 is a concept diagram illustrating the procedure for removing high-frequency components from the target domain LLₙ. This high-frequency component removing procedure will now be described, along with a procedure for producing information about high-frequency dependency indicia, with reference to FIG. 2.

Referring to FIG. 2, a 1-level wavelet transform is additionally executed for the domain LLₙ determined as a target domain, in which watermarks are to be embedded (Step Si). That is, the image of the target domain LLₙ is divided into a DC component domain LLₙ₊₁ having estimate components, and high-frequency component domains LHₙ₊₁, HLₙ₊₁, and HHₙ₊₁ each having detail components, as shown by a block 200 in FIG. 2. Subsequently, the components of frequency bands other than that of the DC components are processed to have a value of “0”, as shown by a block 202 in FIG. 2. Thus, all high-frequency components are removed. An inverse wavelet transform is executed for the block 202 (Step S2). This block 202 is a target block, which has been processed by the 1-level wavelet transform while being in a high-frequency component removed state, and in which watermarks are to be embedded. In accordance with the inverse wavelet transform, a new domain LLₙ′ free of high-frequency components is produced.

Although the domain LLₙ has high-frequency components, the domain LLₙ′ is completely free of those high-frequency components. Accordingly, the difference between the pixel data streams in the domains LLₙ and LLₙ′, X, calculated by the following Expression 2, represents the dependency of the domain LLₙ on high-frequency components.

X=|LLₙ−LLₙ′| [Expression 2]

The pixel data stream difference X between the domains LLₙ and LLₙ′ is calculated for every pixel (Step S3). All pixel data stream differences X calculated for all pixels are then arranged in the order of higher values, and then stored as index information (Step S4). Based on the stored index information, a watermark data stream is embedded in the target domain LLₙ, starting from the position of its pixel exhibiting a maximum pixel data value difference X, that is, a maximum high-frequency dependency. In accordance with this method, it is possible to greatly reduce a degradation in picture quality, in spite of the embedding of the watermark data stream in the wavelet-transformed DC component domain.

FIG. 3 is a block diagram illustrating an apparatus for embedding digital watermarks based on wavelets in accordance with an embodiment of the present invention. In FIG. 3, the apparatus is denoted by the reference numeral 300. Now, the digital watermark embedding operation of the apparatus 300 will be described with reference to FIG. 3. In response to inputting of a target image LL corresponding to a target domain, which has been processed by a wavelet transform according to the size of watermarks to be embedded, and in which the watermarks are to be embedded, a high-frequency component removing unit 302 included in the apparatus 300 conducts a 1-level wavelet transform for the target image LL so as to wavelet-transform again the target image LL. Thus, the target image LL is divided into an estimate domain, that is, a DC component domain, and detail domains. Subsequently, the high-frequency component removing unit 302 replaces, with a value of “0”, the values of high-frequency components in the detail domains of the target image LL, except for the DC component domain, thereby removing those high-frequency components. The high-frequency component removing unit 302 then performs an inverse wavelet transform for the target image LL, thereby outputting a mirror image LL′ corresponding to the target image LL, but free of the high-frequency components. The mirror image LL′ is inputted, along with the target image LL, to an index information generating unit 304 which, in turn, calculates the pixel data value difference X between the original and mirror images LL and LL′ for every pixel, so as to calculate the high-frequency dependency of each pixel in the target image LL. The index information generating unit 304 then arranges position information about all pixels in the order of higher values of “X”, that is, the order of higher high-frequency dependencies, and generates index information idx(i) indicative of the arranged pixel position information. Based on the index information idx(i), a watermark data stream is embedded in the pixels of the target image LL. Since a higher “X” value represents a correspondingly higher high-frequency dependency of the associated pixel, the embedding of the watermark data stream in the pixels in the order of higher high-frequency dependencies makes it possible to minimize a degradation in picture quality caused by the embedded watermark data stream.

That is, the index information idx(i) indicative of the arrangement of position information about all pixels in the target image LL in the order of higher high-frequency dependencies is applied from the index information generating unit 304 to the watermark embedding unit 306. The watermark embedding unit 306 receives a watermark data stream w(i) generated from a watermark generating unit 308, along with the target image LL.

Using the index information idx(i) applied from the index information generating unit 304, the watermark embedding unit 306 sequentially embeds the watermark data, received from the watermark generating unit 308, in the pixels of the target image LL in the order of higher high-frequency dependencies, thereby generating an image LL″, in which the watermark data stream w(i) is embedded.

For the watermark data stream w(i), a sequence of Gaussian noise having an average value of “0” and a spreading value of “1” is used. The watermark data stream is produced in the form of a random noise signal having a format set in accordance with a key value selected by the user. Watermark data streams produced according to different key values have a correlation set to a value of “0”, whereas watermark data streams produced according to the same key value have a correlation set to a specific high value. That is, the watermark embedding unit 306 replaces respective data values of the pixels in the target image LL with new pixel data values reflecting watermark data values in the order of pixels having higher high-frequency dependencies, thereby generating a new watermark-embedded pixel data stream, that is, the image LL″, as expressed by the following Expression 3:

LL″(idx(i))=LL(idx(i))·(1+aw(i)) [Expression 3]

In the Expression 3, “a” is a factor for controlling the watermark embedding strength. In accordance with an adjustment of the value of “a” by the user, it is possible to adjust the watermark embedding strength.

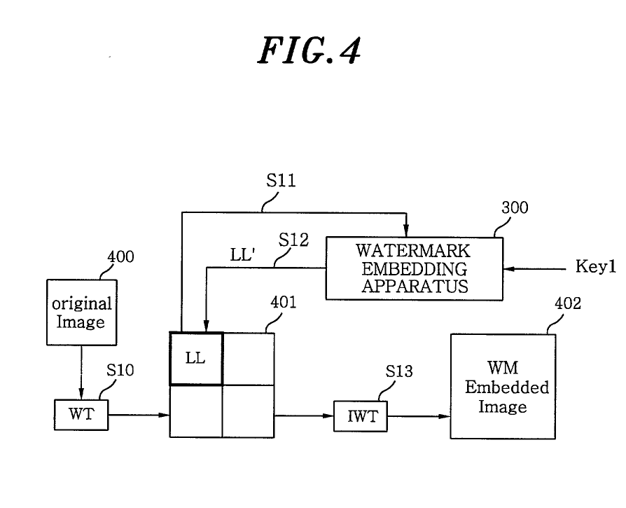

FIG. 4 illustrates a procedure for embedding watermarks based on wavelets using the watermark embedding apparatus 300 in accordance with an embodiment of the present invention. With reference to FIG. 4, the operation of producing a watermark-embedded image 402 from an original image 400 will be described.

Where there is a particular original image, that is, the original image 400, in which watermarks are to be embedded, an appropriate wavelet transform level is determined in accordance with the size of the watermarks to be embedded (Step S10). At step S10, a wavelet transform is then performed for the original image 400 at the determined level. The wavelet transform level is appropriately determined to prevent the original image 400 from being degraded in picture quality due to the embedding of watermarks therein. Thereafter, an target image LL is applied to the watermark embedding apparatus 300 (Step S11). This target image LL corresponds to a target domain, which is included in the wavelet-transformed image and in which watermarks are to be embedded. The watermark embedding apparatus 300 processes the target image LL to remove high-frequency components therefrom, thereby producing a mirror image LL′ free of the high-frequency components. Thereafter, the high-frequency dependency of each pixel in the target image LL is calculated, based on the pixel data value difference between the target image LL and the mirror image LL′ for the pixel. The watermark embedding apparatus 300 then produces a new image LL″ by embedding a watermark data stream, produced in accordance with a key value entered by the user, in all pixels of the target image LL in the order of higher high-frequency dependency. That is, the watermark-embedded image LL″ is embedded in the target domain, in place of the target image LL (Step S12). The resultant image 401 including the watermark-embedded image LL″ is subjected to an inverse wavelet transform (Step S13). As a result, a watermark-embedded image 402 is outputted. Thus, the production of the watermark-embedded image is completed. In accordance with the illustrated embodiment of the present invention, the watermarks are robust to external attacks such as compression because they are embedded in the DC components of the wavelet-transformed original image. Also, it is possible to prevent a degradation in quality caused by the embedding of watermarks in the DC domain because the watermarks are embedded in the pixels of the DC domain in the order of higher high-frequency dependency.

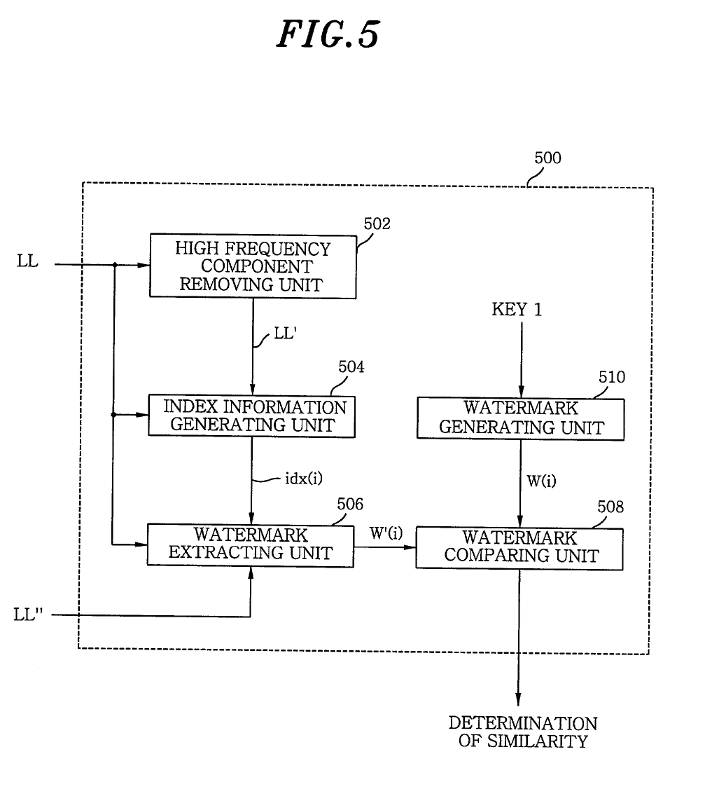

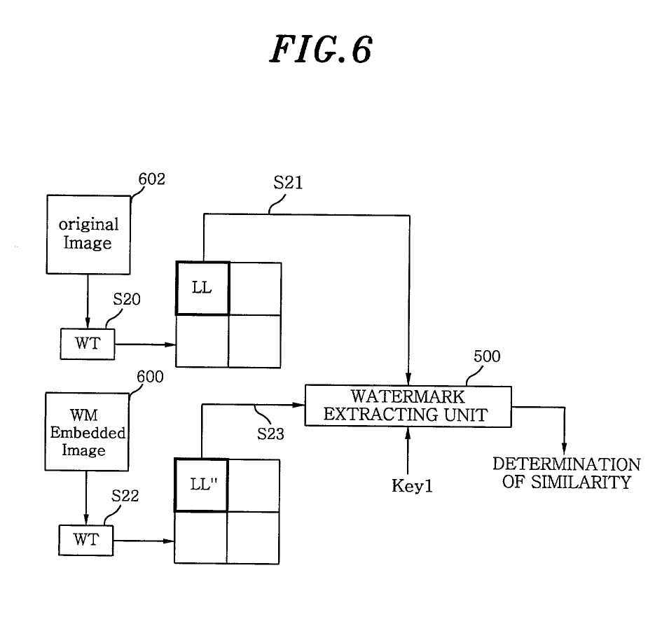

FIG. 5 is a block diagram illustrating an apparatus for extracting digital watermarks based on wavelets in accordance with an embodiment of the present invention. The operation of the digital watermark extracting apparatus will be described with reference to FIG. 5.

In order to extract watermarks from an watermark-embedded image LL″, it is necessary to derive position information about the embedded watermarks, based on an associated target image LL. That is, the watermark extracting apparatus 500 first produces a mirror image LL′ by removing high-frequency components from an target image LL corresponding to a target domain, in which watermarks are to be embedded, through a high-frequency component removing unit 502. The mirror image LL′ from the high-frequency component removing unit 502 is applied to an index information generating unit 504 which, in turn, calculates the pixel data value difference X between the original and mirror images LL and LL′ for every pixel, thereby generating index information idx(i) indicative of information about the watermark embedded positions of the pixels in the target image LL. The index information idx(i) is applied to a watermark extracting unit 506.

Based on the index information idx(i), the watermark extracting unit 506 extracts a watermark data stream from the watermark-embedded pixels in the watermark-embedded domain. That is, the watermark extracting unit 506 extracts a watermark data stream w′ (i), using the data stream of the target image LL and the data stream of the watermark-embedded image LL″, as expressed by the following Expression 4:

$${w}^{′} ( i ) = \frac{\frac{{LL}^{″} ( idx ( i ) )}{LL ( idx ( i ) )} - 1}{a} \qquad [ Expression 4 ]$$

The extracted watermark data stream w′ (i) is applied to a watermark comparing unit 508. The watermark comparing unit 508 compares the extracted watermark data stream w′ (i) with the original watermark data stream w(i) applied thereto from a watermark generating unit 510, in terms of similarity, thereby determining whether or not there are watermarks in associated pixels. As described above, the watermark data stream is a Gaussian noise sequence having an average value of “0” and a spreading value of “1”. That is, the watermark data stream is a data stream having a correlation with another watermark data stream in such a fashion that the correlation is set to a high value when the correlated watermark data streams are produced according to the same key value, while being set to a value of “0” when the correlated watermark data streams are produced according to different key values. Accordingly, the similarity between the extracted watermark data stream w′ (i) and the original watermark data stream w(i) can be determined by computing the correlation value between those watermark data streams w′ (i) and w(i), as expressed by the following Expression 5:

$$Sim ( w , {w}^{′} ) = \frac{{\sum }_{i = 1}^{WM Length} w ( i ) \cdot {w}^{′} ( i )}{{\sum }_{i = 1}^{WM Length} {w}^{′} ( i ) \cdot {w}^{′} ( i )} \qquad [ Expression 5 ]$$

Where the value of similarity, Sim, corresponds to a high value, the two watermark data streams are determined to be signals having a high correlation. That is, the two watermark data streams in this case are determined to be identical to each other. On the other hand, where the value of similarity, Sim, corresponds to a low value, the two watermark data streams are determined to be signals having no correlation. That is, the two watermark data streams in this case are determined to be different from each other. In the latter case, it is determined that no watermark is embedded in the image.

FIG. 6 illustrates a procedure for extracting watermarks based on wavelets using the digital watermark extracting apparatus 500 in accordance with an embodiment of the present invention. Now, the procedure for extracting watermarks from a watermark-embedded image 600 will be described in detail with reference to FIG. 6.

In order to extract watermarks from the watermark-embedded image 600, it is necessary to derive position information about the embedded watermarks. That is, a wavelet transform is first executed for an original image 602 in the same fashion as the watermark embedding procedure (Step S20). Thereafter, an target image LL corresponding to a target domain of the wavelet-transformed original image 602, in which watermarks are to be embedded, is applied to the watermark extracting apparatus 500 (Step S21). Meanwhile, the watermark-embedded image 600 is processed by a wavelet transform to produce a watermark-embedded image LL″ corresponding to a watermark-embedded domain of the watermark-embedded image 600 (Step S22). Pixel data of the watermark-embedded image LL″ is then applied to the watermark extracting apparatus 500 (Step S23). The watermark extracting apparatus 500 produces, based on the target image LL, position information about pixels, in which watermarks are to be embedded, and extracts a watermark data stream from the pixel data of the watermark-embedded image LL″, based on the pixel position information. Thereafter, the watermark extracting apparatus 500 performs a similarity checking process by a comparison of the extracted watermark data stream with an original watermark data stream, thereby determining whether or not the original watermarks are embedded in the watermark-embedded image 600.

In accordance with the present invention, the embedding of watermarks based on wavelets is carried out by detecting position information about pixels having higher high-frequency dependencies from the DC component domain of a wavelet-transformed original image, and embedding watermark information in the original image the order of the pixels having higher high-frequency dependencies. Accordingly, it is possible to achieve an enhanced robustness of the embedded watermarks while preventing a degradation in picture quality caused by the embedding of the watermark in the DC component domain.

Although the preferred embodiments of the invention have been disclosed for illustrative purposes, those skilled in the art will appreciate that various modifications, additions and substitutions are possible, without departing from the scope and spirit of the invention as disclosed in the accompanying claims. For example, although procedures of embedding watermarks in a DC component domain based on wavelets, and extracting those watermarks have been described in conjunction with the preferred embodiments of the present invention associated with images, the present invention may be equivalently applied to audio, video, and text images. Therefore, the scope of the invention should be defined by the claims without being defined by the illustrated embodiments.

As apparent from the above description, the present invention provides an apparatus and method for embedding and extracting digital watermarks based on wavelets, in which the watermarks are embedded in DC component domains of wavelet-transformed domains. Accordingly, the embedded watermarks can be robust to external attacks such as compression. In accordance with the present invention, the high-frequency dependency of pixels in a DC component domain determined as a target domain, in which watermarks are to be embedded, is calculated, in order to embed the watermarks in the target domain in the order of pixels having a higher high-frequency dependency. Accordingly, there is an advantage in that it is possible to minimize a degradation in picture quality caused by the embedding of watermarks in the DC component domain. In future, it may also be possible to maintain a desired robustness of watermarks to diverse attacks such as data loss, deletion, and compression in, for example, JPEG2000 based on wavelets.

While the invention has been shown and described with respect to the preferred embodiments, it will be understood by those skilled in the art that various changes and modifications may be made without departing from the spirit and scope of the invention as defined in the following claims.

What is claimed is:

1. A digital watermark embedding apparatus based on wavelets comprising:
a high-frequency component removing unit for removing high-frequency components from a target image corresponding to a target domain of a wavelet-transformed original image, in which watermarks are to be embedded, thereby generating a mirror image corresponding to the target domain free of high-frequency components;
an index information generating unit for comparing data values of pixels in the target image with data values of pixels in the mirror image, respectively, thereby detecting position information of the pixels having higher high-frequency dependencies in the target image, the index information generating unit serving to arrange the detected pixel position information in the order of pixels having higher high-frequency dependencies, thereby generating an index information about the arranged pixel position information;
a watermark generating unit for generating a data stream of the watermarks to be embedded in the target image; and
a watermark embedding unit for embedding the watermarks of the watermark data stream generated from the watermark generating unit in pixel data of the target image at positions determined based on the index information from the index information generating unit, respectively.

2. The digital watermark embedding apparatus based on wavelets according to claim 1, wherein the high-frequency component removing unit generates the mirror image by performing again a 1-level wavelet transform for the target domain of the wavelet-transformed original image, removing high-frequency components from detail domains of the wavelet-transformed target domain, except for an estimate component domain of the wavelet-transformed target domain, and performing an inverse wavelet transform for the resultant target domain.

3. The digital watermark embedding apparatus based on wavelets according to claim 2, wherein the high-frequency component removing unit removes high-frequency components from the target image by replacing, with a value of “0”, values of the high-frequency components in the detail domains of the wavelet-transformed target domain.

4. The digital watermark embedding apparatus based on wavelets according to claim 1, wherein the index information generating unit calculates a pixel data value difference between the target and mirror images for every pixel, determines, as pixels having a higher high-frequency dependency, the pixels of the target image exhibiting a higher pixel data value difference, and arranges the position information about the pixels of the target image in the order of higher high-frequency dependencies in order to generate the index information about the arranged pixel position information.

5. The digital watermark embedding apparatus based on wavelets according to claim 1, wherein the target domain, in which the watermarks are to be embedded, corresponds to a DC component domain obtained from the original image subjected to a wavelet transform at a level determined by a length and embedding strength of the watermark data stream to be embedded, and the level of a degradation in picture quality caused by the embedding of the watermark data stream.

6. The digital watermark embedding apparatus based on wavelets according to claim 1, wherein the watermark data stream is a random noise signal having an average value of “0” and a spreading value of “1”.

7. The digital watermark embedding apparatus based on wavelets according to claim 1, wherein the watermark data stream generated by the watermark generating unit has the form of a random noise signal having a format set in accordance with a key value selected by a user so that watermark data streams generated according to different key values have a correlation set to a value of “0”, so as to discriminate a similarity between the watermark data streams.

8. The digital watermark embedding apparatus based on wavelets according to claim 1, wherein the watermark embedding unit embeds the watermark data stream generated from the watermark generating unit in the pixels of the target image in the order of higher high-frequency dependencies.

9. The digital watermark embedding apparatus based on wavelets according to claim 1, wherein the watermark embedding unit embeds the watermark data stream in the target image by replacing respective data values of the pixels in the target image with new pixel data values reflecting watermark data values in the order of pixels having higher high-frequency dependencies, as expressed by the following Expression:
LL“(idx(i))=LL(idx(i))·(1+aw(i)) [Expression]
where,
idx(i): position information of pixels in a target domain, in which watermarks are to be embedded, arranged in the order of higher high-frequency dependencies;
LL: a data stream of pixels in a wavelet-transformed DC domain corresponding to the target domain;
LL″: a data stream of pixels in the wavelet-transformed DC domain, in which the watermarks has been embedded;
w(i): a data stream of the watermarks having the form of a random noise signal having an average value of “0” and a spreading value of “1”; and
a: a factor for controlling an embedding strength of the watermarks.

10. A digital watermark extracting apparatus based on wavelets comprising:
a high-frequency component removing unit for removing high-frequency components from a target image corresponding to a target domain of a wavelet-transformed original image, in which original watermarks are to be embedded, thereby generating a mirror image corresponding to the target domain free of high-frequency components;
an index information generating unit for comparing data values of pixels in the target image with data values of pixels in the mirror image, respectively, thereby detecting position information of the pixels having higher high-frequency dependencies in the target image, the index information generating unit serving to arrange the detected pixel position information in the order of pixels having higher high-frequency dependencies, thereby generating an index information about the arranged pixel position information;
a watermark generating unit for generating a data stream of the original watermarks to be embedded in the target image;
a watermark extracting unit for receiving the index information from the index information generating unit, receiving a watermark-embedded image corresponding to a watermark-embedded domain of the wavelet-transformed original image, and extracting a data stream of watermarks from in the watermark-embedded image, based on the index information; and
a watermark comparing unit for checking a similarity between the original watermark data stream from the watermark generating unit and the extracted watermark data stream from the watermark extracting unit, thereby determining whether or not the original watermarks are embedded in the wavelet-transformed original image.

11. The digital watermark extracting apparatus based on wavelets according to claim 10, wherein the high-frequency component removing unit generates the mirror image by performing again a 1-level wavelet transform for the target domain of the wavelet-transformed original image, removing high-frequency components from detail domains of the wavelet-transformed target domain, except for an estimate component domain of the wavelet-transformed target domain, and performing an inverse wavelet transform for the resultant target domain.

12. The digital watermark extracting apparatus based on wavelets according to claim 11, wherein the high-frequency component removing unit removes high-frequency components from the target image by replacing, with a value of “0”, values of the high-frequency components in the detail domains of the wavelet-transformed target domain.

13. The digital watermark extracting apparatus based on wavelets according to claim 10, wherein the index information generating unit calculates a pixel data value difference between the target and mirror images for every pixel, determines, as pixels having a higher high-frequency dependency, the pixels of the target image exhibiting a higher pixel data value difference, and arranges the position information about the pixels of the target image in the order of higher high-frequency dependencies in order to generate the index information about the arranged pixel position information.

14. The digital watermark extracting apparatus based on wavelets according to claim 10, wherein the target domain, in which the watermarks are to be embedded, corresponds to a DC component domain obtained from the original image subjected to a wavelet transform at a level determined by a length and embedding strength of the watermark data stream to be embedded, and the level of a degradation in picture quality caused by the embedding of the watermark data stream.

15. The digital watermark extracting apparatus based on wavelets according to claim 10, wherein the watermark data stream is a random noise signal having an average value of “0” and a spreading value of “1”.

16. The digital watermark extracting apparatus based on wavelets according to claim 10, wherein the watermark data stream generated by the watermark generating unit has the form of a random noise signal having a format set in accordance with a key value selected by a user so that watermark data streams generated according to different key values have a correlation set to a value of “0”, so as to discriminate a similarity between the watermark data streams.

17. The digital watermark extracting apparatus based on wavelets according to claim 10, wherein the watermark extracting unit extracts the watermark data stream from the watermark-embedded image in accordance with a calculation executed based on the index information while using the following Expression:
$${w}^{′} ( i ) = \frac{\frac{{LL}^{″} ( idx ( i ) )}{LL ( idx ( i ) )} - 1}{a} \qquad [ Expression ]$$
where,
w′ (i): the extracted watermark data stream;
LL″: a data stream of pixels in the watermark-embedded domain; and
LL: a data stream of pixels in the target domain, in which no watermark is embedded.

18. The digital watermark extracting apparatus based on wavelets according to claim 10, wherein the watermark comparing unit checks the similarity between the watermark data stream from the watermark generating unit and the extracted watermark data stream from the watermark extracting unit by calculating a correlation value between the watermark data streams.

19. The digital watermark extracting apparatus based on wavelets according to claim 18, wherein the watermark comparing unit calculates the correlation value between the watermark data streams using the following Expression, and determines that the original watermarks are embedded in the wavelet-transformed original image when the calculated correlation value is high, while determining that the original watermarks are not embedded in the wavelet-transformed original image when the calculated correlation value is low:
$$Sim ( w , {w}^{′} ) = \frac{{\sum }_{i = 1}^{WM Length} w ( i ) \cdot {w}^{′} ( i )}{{\sum }_{i = 1}^{WM Length} {w}^{′} ( i ) \cdot {w}^{′} ( i )} \qquad [ Expression ]$$
where,
WM_Length: a watermark data stream length;
w(i): the watermark data stream from the watermark generating unit; and
w′ (i) : the extracted watermark data stream from the watermark extracting unit.

20. A digital watermark embedding method based on wavelets in a digital watermark embedding apparatus including a high frequency removing unit, an index information generating unit, a watermark generating unit, and a watermark embedding unit, comprising the steps of:
(a) executing a multi-level wavelet transform at a level corresponding to the size of a data stream of watermarks to be embedded, for an original image, in which the watermarks are to be embedded, and setting a target domain of the wavelet-transformed image, in which the watermarks are to be embedded;
(b) removing high-frequency components from a target image corresponding to the set target domain, thereby generating a mirror image corresponding to the target image, but free of high-frequency components;
(c) comparing data values of pixels in the target image with data values of pixels in the mirror image, respectively, thereby detecting position information of the pixels having higher high-frequency dependencies in the target image, and arranging the detected pixel position information in the order of pixels having higher high-frequency dependencies, thereby generating an index information about the arranged pixel position information; and
(d) embedding the watermarks of the watermark data stream in pixel data of the target image at positions determined based on the index information, respectively.

21. The digital watermark embedding method based on wavelets according to claim 20, wherein the step (c) comprises the steps of:
(c1) calculating a pixel data value difference between the target and mirror images for every pixel; and
(c2) determining, as pixels having a higher-frequency dependency, the pixels of the target image exhibiting a higher pixel data value difference, and arranging the position information about the pixels of the target image in the order of higher high-frequency dependencies, thereby generating the index information about the arranged pixel position information.

22. The digital watermark embedding method based on wavelets according to claim 20, wherein the step (d) comprises the steps of:
(d1) reading the position information of the pixels in the target image in the order of higher high-frequency dependencies; and
(d2) embedding the watermark data stream in the pixel data of the target image in the order of pixels having higher high-frequency dependencies.

23. The digital watermark embedding method based on wavelets according to claim 20, wherein the watermark data stream is embedded in the target image by replacing respective data values of the pixels in the target image with new pixel data values reflecting watermark data values in the order of pixels having higher high-frequency dependencies, as expressed by the following Expression:
LL″(idx(i))=LL(idx(i))·(1+aw(i)) [Expression]
where,
idx(i): position information of pixels in a target domain, in which watermarks are to be embedded, arranged in the order of higher high-frequency dependencies;
LL: a data stream of pixels in a wavelet-transformed DC domain corresponding to the target domain;
LL″: a data stream of pixels in the wavelet-transformed DC domain, in which the watermarks has been embedded;
w(i): a data stream of the watermarks having the form of a random noise signal having an average value of “0” and a spreading value of “1”; and
a: a factor for controlling an embedding strength of the watermarks.

24. The digital watermark embedding method based on wavelets according to claim 23, wherein the watermark data stream is a random noise signal having an average value of “0” and a spreading value of “1”.

25. The digital watermark embedding method based on wavelets according to claim 24, wherein the watermark data stream has the form of a random noise signal having a format set in accordance with a key value selected by a user so that watermark data streams generated according to different key values have a correlation set to a value of “0”, so as to discriminate a similarity between the watermark data streams.

26. The digital watermark embedding method based on wavelets according to claim 20, wherein the target domain, in which the watermarks are to be embedded, corresponds to a DC component domain obtained from the original image subjected to a wavelet transform at a level determined by a length and embedding strength of the watermark data stream to be embedded, and the level of a degradation in picture quality caused by the embedding of the watermark data stream.

27. A digital watermark extracting embedding method based on wavelets in a digital watermark extracting apparatus including a high frequency removing unit, an index information generating unit, a watermark generating unit, a watermark extracting unit, and a watermark comparing unit, comprising the steps of:
(a′) generating position information about pixels, in which a data stream of original watermarks is to be embedded, based on a target image corresponding to a target domain of a wavelet-transformed original image, in which the target watermark data stream is to be embedded;
(b′) receiving data of pixels in a watermark-embedded domain, in which the original watermark data stream has been embedded;
(c′) extracting a watermark data stream from the received pixel data, based on the pixel position information; and
(d′) checking a similarity between the original watermark data stream and the extracted watermark data stream, thereby determining whether or not the original watermarks are embedded in the wavelet-transformed original image.

28. The digital watermark extracting embedding method based on wavelets according to claim 27, wherein the step (a′) comprises the steps of:
(a′1) executing a multi-level wavelet transform for an original image, in which the original watermarks are to be embedded, thereby setting a target domain of the wavelet-transformed image, in which the original watermarks are to be embedded;
(a′2) removing high-frequency components from a target image corresponding to the set target domain, thereby generating a mirror image corresponding to the target image, but free of high-frequency components; and
(a′3) comparing data values of pixels in the target image with data values of pixels in the mirror image, respectively, thereby detecting position information of the pixels having higher high-frequency dependencies in the target image, and generating information about positions, at which the watermarks are to be embedded, based on the detected pixel position information.

29. The digital watermark extracting embedding method based on wavelets according to claim 27, wherein the step (c′) comprises the steps of:
(c′1) reading the pixels in the target domain in the order of higher high-frequency dependencies; and
(c′2) sequentially extracting the watermark data stream embedded in the read pixels, starting from the pixel having a maximum high-frequency dependency.

30. The digital watermark extracting embedding method based on wavelets according to claim 27, the embedded watermark data stream is extracted from a data stream of the pixels in the watermark-embedded domain in accordance with a calculation executed based on the position information while using the following Expression:
$${w}^{′} ( i ) = \frac{\frac{{LL}^{″} ( idx ( i ) )}{LL ( idx ( i ) )} - 1}{a} \qquad [ Expression ]$$
where,
w′ (i): the extracted watermark data stream;
LL″: the data stream of the pixels in the wartermark-embedded domain; and
LL: a data stream of the pixels in the target domain, in which no watermark is embedded.

31. The digital watermark extracting method based on wavelets according to claim 27, wherein the determination of whether or not the original watermarks are embedded in the wavelet-transformed original image at the step (d′) comprises the steps of:
calculating the correlation value between the watermark data streams using the following Expression; and
determining that the original watermarks are embedded in the wavelet-transformed original image when the calculated correlation value is high, while determining that the original watermarks are not embedded in the wavelet-transformed original image when the calculated correlation value is low:
$$Sim ( w , {w}^{′} ) = \frac{{\sum }_{i = 1}^{WM Length} w ( i ) \cdot {w}^{′} ( i )}{{\sum }_{i = 1}^{WM Length} {w}^{′} ( i ) \cdot {w}^{′} ( i )} \qquad [ Expression ]$$
where,
WM_Length: a watermark data stream length;
w(i): the original watermark data stream; and
w′(i): the extracted watermark data stream.

32. The digital watermark extracting method based on wavelets according to claim 31, wherein the watermark data stream is a random noise signal having an average value of “0” and a spreading value of “1”.

33. The digital watermark extracting method based on wavelets according to claim 32, wherein the watermark data stream has the form of a random noise signal having a format set in accordance with a key value selected by a user so that watermark data streams generated according to different key values have a correlation set to a value of “0”, so as to discriminate a similarity between the watermark data streams.

34. The digital watermark extracting method based on wavelets according to claim 27, wherein the target domain, in which the watermarks are to be embedded, corresponds to a DC component domain obtained from the original image subjected to a wavelet transform at a level determined by a length and embedding strength of the watermark data stream to be embedded, and the level of a degradation in picture quality caused by the embedding of the watermark data stream.
